(19) United States
(12) Patent Application Publication
(10) Pub. No.: US 2012/0106540 A1
(43) Pub. Date: May 3, 2012

(54) Secure Traffic Separation and Management Method

(76) Inventors: Tim Moyers, Richardson, TX (US); Jeff Tsao, Richardson, TX (US)

(21) Appl. No.: 12/917,021

(22) Filed: Nov. 1, 2010

(51) Int. Cl. H04L 12/66

(52) U.S. Cl. 370/352

(57) ABSTRACT

The present invention is a method for securing internet communications between various voice over IP (VoIP) applications. The method enables VoIP Devices to operate within multiple IP networks which are physically connected to the VoIP Device in a manner that ensures inbound and outbound network traffic separation from other connected IP networks based on applicable Security Classifications of the VoIP Device and/or VoIP Device user.

### CROSS-REFERENCE TO RELATED APPLICATIONS

None

### TECHNICAL FIELD

The present invention is relates to an apparatus for securing internet communications between various voice over IP (VoIP) applications and devices. Internet communications may consist of multiple security levels, such as top secret, secret, confidential or unclassified, or other designation.

### BACKGROUND

Voice over Internet Protocol (VOIP) has been readily adopted in the U.S. given the expansive of network architecture capable of maintain speeds required to make VOIP reliable. Although VOIP is maturing, VoIP security is a growing challenge and has not been effective dealt with in the past until the present invention. VoIP communication is increasingly moving from being within a trusted network to flowing out to un-trusted ones. This poses several security related threats to the network as well as the systems supporting it. It is speculated that voice communication over un-trusted networks will be safe from major spam or worm based attacks till critical mass is reached.

Rather than security, most VoIP Device users have been focused on concerns about voice quality, latency and interoperability. It is only as the market for VOIP has matured that VoIP Device users had begun to realize their focus has been misplaced. VoIP Device users are now making security their top concern as latency and quality issues have resolved. It should be noted that there currently is not precedence for security breaches to VoIP communication. It is often these security breach precedences that often give rise to VoIP Device users to invest in the infrastructure to enhance security. Therefore users haven't felt the need to invest in security infrastructure to protect their systems and network communication resources. The time for understanding and implementing VoIP Device security related issues has arrived.

Network security increasing will dominate IP telecommunication. Today, consumer markets are getting away without security since it's in its early adoption phase. Once, VoIP reaches its critical mass in the consumer space, security will gain prominence amongst providers who will then view it as a differentiator, more so, with the occurrence of a few incidents of security breach. Security will evolve and become a necessity over time.

Within corporate and governmental enterprises, VoIP communications have mainly been over private circuits and dedicated VoIP infrastructure contained wholly within such enterprises. However, with the growing number of corporate and governmental enterprises deploying VoIP infrastructure and making use of the un-trusted IP networks and VoIP infrastructure for intra/inter enterprise communications, there is a growing demand for security systems to protect such network components and VoIP infrastructure from malicious attack, both from within and outside their internal networks and domains. Communications over VoIP infrastructure are exposed to several vulnerabilities which are likely to convert into security threats. Securitizing VoIP communications has historically been difficult due to an intolerance to the jitter and latency which inherently accompanies implementing security protocols and techniques within VoIP infrastructure.

The present invention is an improved method of managing and securing VOIP communications. The present invention maintains separation of the critical and non-critical traffic by allowing only one (1) network to actively connected to a VoIP Device at a time, such connection driven by the VoIP Device, the VoIP Device user, and the primary server wherein the networks connected to the VoIP Device have assigned Security Classifications by a system administrator. At all times, the Signaling Processor of the present invention maintains persistent connections to all IP networks associated with incoming signals to the VoIP Device; however, the Media Processor serially processes a single IP network at a time and disregards (drops) all other media packets not associated with said single network thereby maintaining high integrity and separability of Security Classifications. The single IP network that is processed is the then current IP network selected by the VoIP Device user using the VoIP Device, such VoIP Device user limited to the Security Classifications established by the system administration. Media traffic through the Media Processor do not require a persistent connection and only exist when created by the signaling protocols.

### SUMMARY

The present invention is a method to enable a Voice over IP (VoIP) end instrument, otherwise known as a VoIP telephone, video phone, endpoint or media terminal, (VoIP Device) to interconnect safely and securely to multiple IP networks consisting of multiple Security Classifications. The purpose of the present inventions is to enable operation of a VoIP Device with multiple IP networks, and ensure separation of critical traffic from the different IP networks thereby maintaining the integrity and security of the media traffic. Internet communications may consist of multiple security levels, such as Top Secret (TSSC), Secret (S), Confidential (C) or Unclassified (U), or other designation as may be implemented by a system administrator from time to time (Security Classifications).

FIG. 1 illustrates an implementation of the present invention for interconnection to four (4) separate IP networks each capable of carrying independent Security Classifications. Although four (4) IP networks are shown, the present invention can be scaled in architecture to accommodate two (2) or more IP network connections. Critical traffic typically consists of media such as voice or video, but may also consist of images, text or other possible media types such as graphics, documents, photographs, HTML, XML, JAVA, websites, links of other interne based protocols (Media Types). In the implementation of the present invention, it is essential that the critical traffic from different networks must never be mixed even though they are accessible from the same VoIP Device. For example, a video stream containing sensitive data on a Top Secret network must never be accessible on the Secret, Confidential or Unclassified networks. Media, such as voice or video, and other Media Types are typically transported using the Real Time Protocol (RTP) or the Secure Real Time Protocol (SRTP). RTP and/or SRTP packets are separated by the Media Separator from the rest of IP network traffic in a manner which prevents the comingling of data of differing Security Classifications between the various IP networks.

Non critical traffic consists of all other non-media packets. The non-critical traffic of particular interest to the present invention are the set of IP protocols that are required to setup, operate and maintain connectivity to a VoIP Device. Non-critical protocols include the following: 1) a signaling protocol for setting up IP media flows such as Skinny Client Control Protocol (SCCP), 2) session Initiation Protocol (SIP), and 3) H.323. Protocols required to enable basic operation of the VoIP Device over Ethernet and IP include, but are not limited to, the following: 1) Address Resolution Protocol (ARP); 2) Domain Name System (DNS); 3) Dynamic Host Configuration Protocol (DHCP); 4) Internet Control Message Protocol (ICMP); and 5) other IP application level protocols that may be used to enable advanced IP telephony features, including but not limited to: i) Hyper Text Transport Protocol (HTTP), ii) Secure Sockets Layer (SSL), iii) Transport Layer Security (TLS), iv) File Transfer Protocol (FTP), v) Trivial File Transfer Protocol (tFTP), vi) Secure File Transfer Protocol (SFTP).

FIG. 1 indicates the paths of the critical (media) and non-critical traffic. As traffic from the various IP networks enters the VoIP Device, or other implementation of the present invention, it is processed by the firewall/media separator block (the “Media Separator”). The firewall function blocks unnecessary or unsolicited protocols from entering the system. The firewall allows only the essential subset of protocols required to support functionality of the VoIP Device.

For the Media Separator function as shown in FIG. 1, media packets are first identified and separated from all other traffic resulting in two streams of traffic 1) signaling and non-media traffic, and 2) media traffic with varying levels of Security Classifications. Media traffic is sent to the Media Separator and, when applicable, to the VoIP Device end user using the VoIP Device for the corresponding ending for the IP Network selected. The “Select” switch, which is switched by the IP network selection of the VoIP Device end user using the VoIP Device, allows for interconnection of a single network to the Media Separator at any given time through the VoIP Device. All other media traffic is unavailable and disregarded by the VoIP Device unless and until the VoIP Device end user selects the network with an appropriate Security Classifications from the VoIP Device.

The present invention maintains separation of the critical and non-critical traffic by allowing only one network to actively connect to the VoIP Device at a time, such connection driven by the VoIP Device, the VoIP Device user, and the primary server wherein the IP networks have been assigned Security Classifications by a system administrator prior to connecting to a VoIP Device. At all times, the Signaling Processor of the present invention maintains persistent connections to all networks associated with incoming IP signals to the VoIP Device; however, the Media Separator processes a single network at a time and disregards (or drops) all other media packets not associated with that single network thereby maintaining high integrity and separability of Security Classifications. Media flows through the Media Separator do not require a persistent connection and only exist when created by the signaling protocols.

A VoIP Device connected to only four (4) networks identified in FIG. 1 would support four (4) different phone numbers each phone number dedicated to a particular IP network(s) each with varying Security Classifications as identified through each physical ports established and secured by a system administrator. A VoIP Device would then contain a selection mechanism for the VoIP Device user to select an IP network on which to make an outgoing call or send media, or receive an incoming call or media. If multiple incoming calls or media transfers were received at the same time from multiple IP networks connected to the VoIP Device, the VoIP Device end user would then be able to choose which one (1) IP network to select, engage the appropriate IP network associated with the designated Security Classifications, and by selection thereof prevent IP traffic flow between the various IP networks of varying Security Classifications. The present invention would not allow outbound or inbound media traffic or voice traffic from an unselected IP network connected to the VoIP Device. VoIP Devices are paired to VoIP Device users, as determined by each physical VoIP Device port(s) established and secured by a system administrator. VoIP Device users would only be capable of receiving calls and/or media on IP networks wherein the VoIP Device user's security clearance matches the Security Classification established and secured by a system administrator for each IP network connected to the VoIP Device.

The Firewall/Media Separator shown in FIG. 1, performs the following: 1) identification of media/critical/signaling packets; 2) routing of packets to the appropriate interface (Signaling Processor or Media Processor); and 3) optional firewall functionality. The Firewall/Media Separator consists of a network processing unit and three ports: 1) a Network Interface Port; 2) a Signaling Processor Port; and 3) a Media Separator Port. The Media Separator unit is capable of examining and analyzing both media and non-media data packets. It is also capable of directing incoming network traffic based on the results of said examination and analysis or inspection of media packet contents, or both. The course of action to be determined depends on the port on which a packet is received. For packets received on any given IP network port, the following courses of action apply: 1) drop (ignore) the packet based; 2) forward the packet to the Signaling Processor port; or 3) forward the packet to the Media Separator port. For packets received through the Media Separator on the Signaling Processor port, the only valid action is to forward that packet to a network interface port for the purpose of maintain a persistent connection with the connected IP networks. For media packets received through the Media Separator which pass through the “select” switch, as selected by the VoIP Device user, such media packets are delivered to the VoIP Device for output to the VoIP Device user. Media packets which are on an IP network other than the current user selected IP network for the VoIP Device are disregarded and dropped; such Media packets never reach the VoIP Device and the VoIP Device end user.

The Media Separator may be implemented in a variety of programmable devices such as an ASIC, FPGA, Network Processor, Microprocessor or Microcontroller. Identification of media/critical/signaling packets may be performed either by packet inspection or by IP port based methods. Operation of a firewall is well understood and will not be discussed in detail. Examples of firewall implementation range from stateless packet filtering, to application layer gateways or circuit-level gateways. Firewall functionality includes, but is not limited to, dropping of all Transmission Control Protocol (TCP)/User Datagram Protocol (UDP) traffic received on the network interface port, except for packets having an allowed destination port number.

As mentioned above, the Signaling Processor must maintain a persistent connection to all incoming IP networks connected to the VoIP Device to avoid disruption of VOIP services.

The liquid crystal display (LCD) of FIG. 3 shows the present invention supporting the same end functionality as a standard VoIP Device. For example, a VoIP Device may consist of an output display, such as a LCD or other display monitor, with or without a video camera, an indication on said output display for identifying and selecting various call states for the incoming VOIP networks and Security Classifications thereon, said output display capable of showing the VoIP Device user videos, graphics, or any other Media Types received by the VoIP Device on the selected IP network. VoIP Device may further consist of a telephone handset and/or a speaker and microphone may be present to support voice communications. A touch interface for user data entry may also exist on the VoIP Device to support line selection, dialing of numbers and other standard phone functions. Such touch interface could be implemented in a variety of ways. Two of the more common methods are to have a number of “hard” buttons and/or some “soft” keys on a touch screen display. FIG. 3, below, illustrates a VoIP Device with video capability, featuring hard buttons, an LCD display with touch screen handset and hands free capability.

In FIG. 3, the LCD display indicates a user interface supporting connectivity to two networks designated as “Secure” and “Non-Secure” as determined by each physical port(s) established and secured by a system administrator as a part of designating Security Classifications. To place an outgoing call on the “Secure” line, the user must first select one of the secure line buttons on the LCD touch screen interface. To answer an incoming call on a “Non-Secure” line, the user must select the appropriate line on the touch screen interface.

A feature of the present invention is that the Media Separator cannot store incoming or outgoing media while connected to one (1) IP network for subsequent transmission on a different IP network. Although unlikely, it is always possible for malicious software were to be loaded onto the Media Separator. There are a variety of mechanisms which can be used to prevent malicious software from being loaded onto the Media Separator: 1) Disable connection from the Media Separator from non-volatile storage during normal operation; 2) reset the media processor when switching the selected network; and/or 3) clear the processor non-volatile memory when switching the selected network. A second mechanism is to use multiple Media Separators to keep the critical data separated, as illustrated below in the following FIG. 4 for the case of three external IP networks:

In FIG. 4, there are individual Media Separators for each network, thereby ensuring separation of the critical network traffic. The architecture shown is also different from existing architecture because it separates the signaling packets, rather than the VOIP media packets. The signaling packets are forwarded to a unified Signaling Processor. All other non-signaling traffic, including media, is sent to the dedicated Network CPU associated with the incoming IP network. This aforementioned design of the present invention satisfies the objectives of ensured separation of media traffic, however, the design is more expensive to realize due to the increased processor count in the implementation.

The present invention also contains a feature to suppress/mitigate leakage of information across media processor interfaces associated with a VoIP Device. The invention as described to this point, critical traffic could be sent between networks using interconnects between the various processors. In either of the architectures presented so far, there exists a necessary interface between the signaling and media processors. It is possible that malicious software loaded onto both processors could compromise separation of the IP networks associated with a VoIP Device thereby sending information through an inappropriate IP network.

In FIG. 5, the curved line from network 4 to network 3 indicates a path interconnecting critical data from network 4 to network 3. In order to mitigate such a connection, the register interface between the Media and Signaling Processors a regulated in the following manner: 1) the register set is limited to include only essential information; 2) the rate at which the information can change in the register set is limited to be as slow as possible; and 3) the maximum rate of change of the information in the register set is much less than the minimum bandwidth required to communicate supported media types

For example, in the present invention the minimum information that must be communicated from the Signaling Processor to the Media Separator includes, but may not be limited to, the following: 1) Network IP address of far end media terminal(s); 2) Media Access Controller (MAC) address of far end media terminal; 3) Network IP address to be used by Media Separator; 4) MAC address to be used by Media Separator; 5) desired voice or video codec to be used; and 6) encryption key to be used to encrypt/decrypt media and other Media Types (optional)

### BRIEF DESCRIPTION OF THE DRAWINGS

FIG. 1 is a High Level Architecture for Multi Level Security;

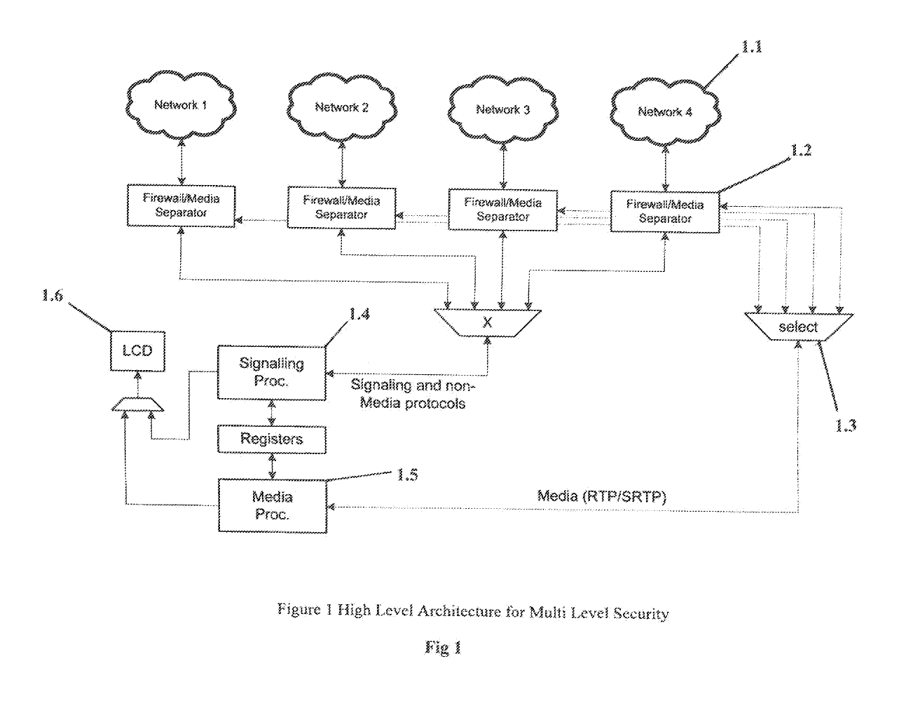

FIG. 2 is a Signaling Processor Network Interfaces;

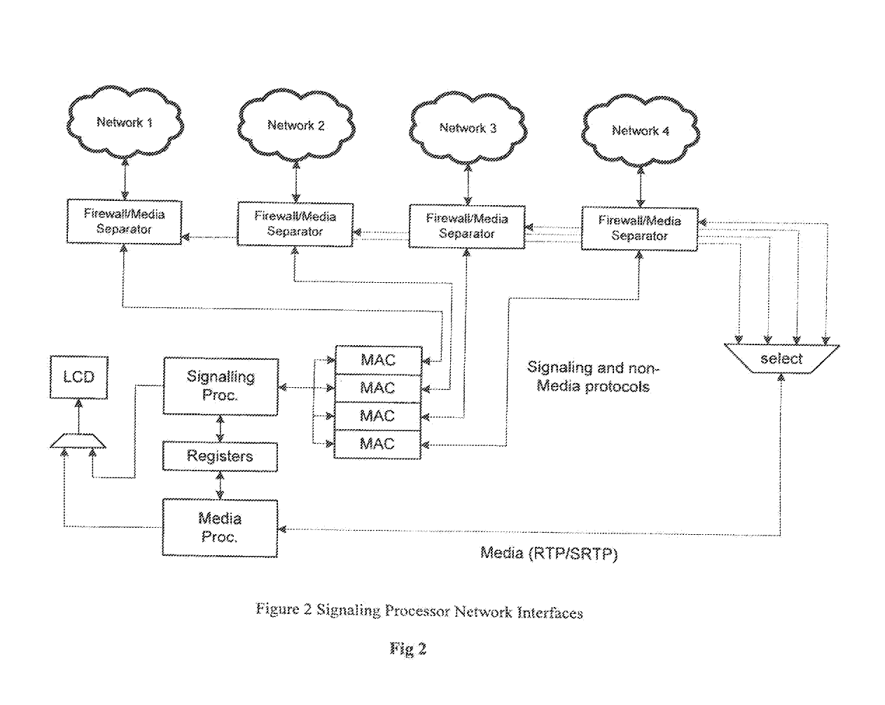

FIG. 3 is an Example of a VoIP Device with Video Capability;

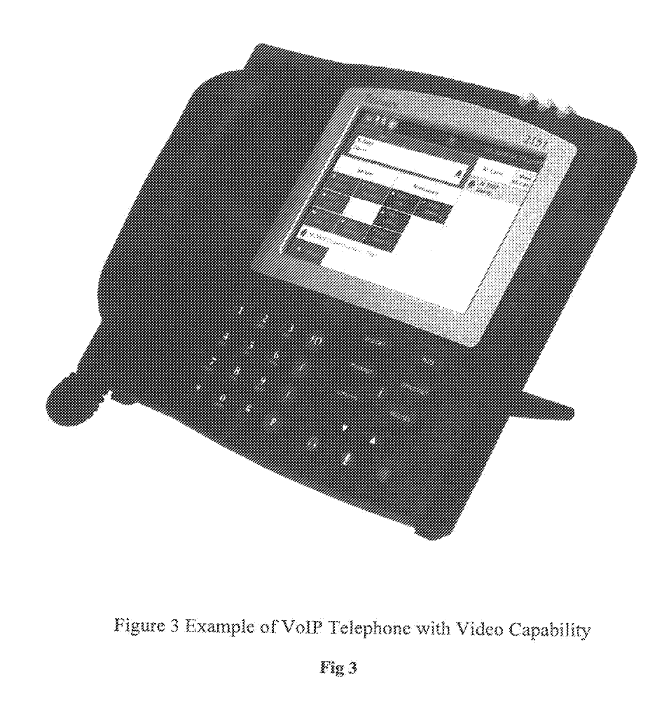

FIG. 4 is an Alternative Architecture for Present Invention;

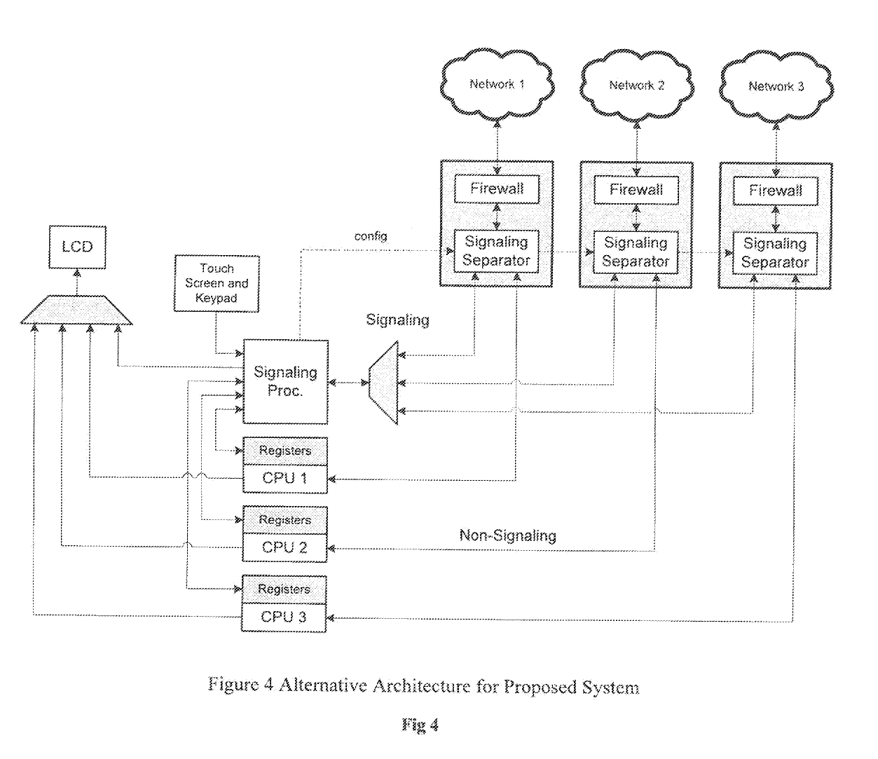

FIG. 5 is a Possible Path for Interconnection of IP Networks;

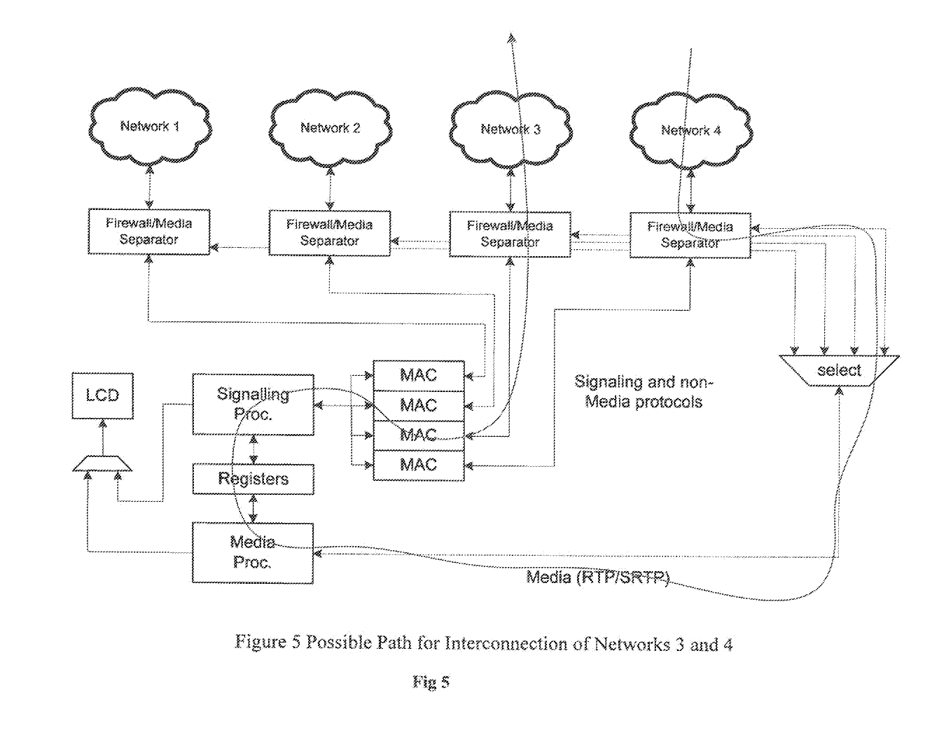

FIG. 6 is a Flow Diagram of an Incoming Signal Analysis and Routing;

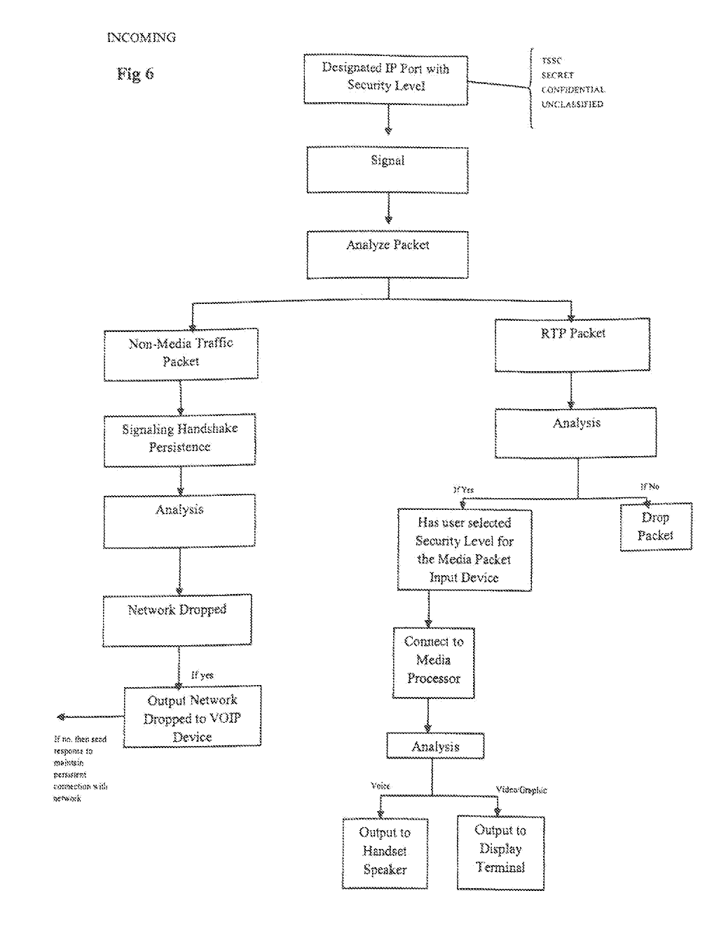

FIG. 7 is a Flow Diagram of an Incoming Call to a VoIP Device;

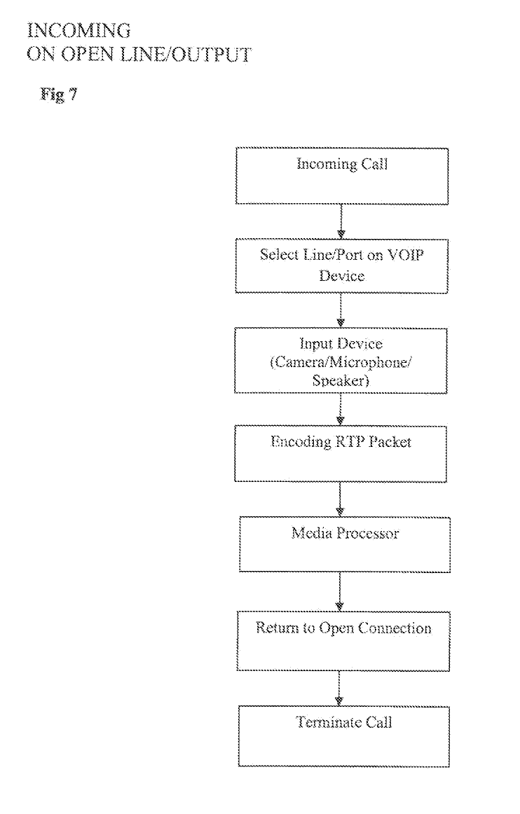

FIG. 8 is a Flow Diagram of an Outgoing Call on a VoIP Device; and

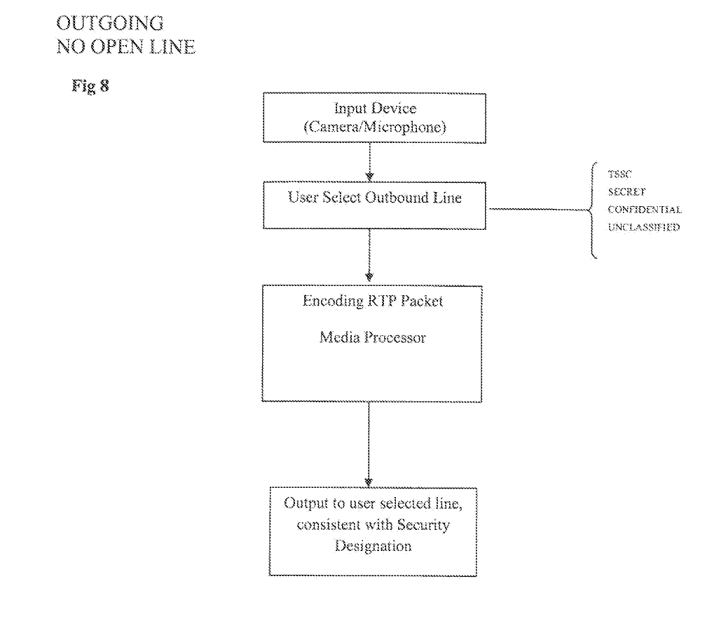

FIG. 9 is a Example of a VoIP Device showing the IP Network connections and interfaces.

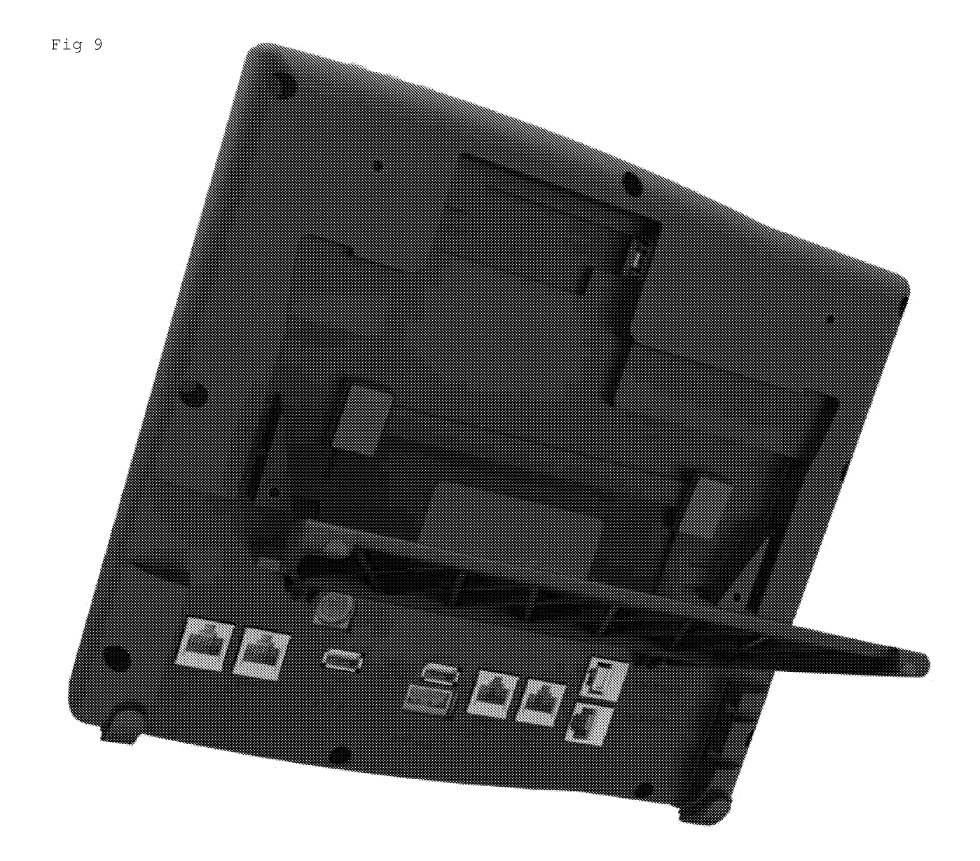

What is claimed is:

1. A method of using an internee protocol (IP) telephone appliance in at least one communication network comprising: a digital phone set, digital phone set user, said digital phone set including a voice input; video output, said digital telephone set including a voice output; a digital signal processor; at least one voice processing module coupled to each of said digital signal processor, at least one media processing module coupled to each of said digital signal processor and said digital telephone set, said at least one processing module including a transport protocol stack and a security stack; at least one local area network interface coupled to said at least one voice processing module and at least one media processing module; and at least one wide area network interface, said at least one wide area network wide area network interface persistently connected to at least one voice processing module and at least one media processing module in said at least one communication network; further characterized in that the incoming IP voice packets, IP media packets, and IP signaling packets, are separated by at least one media separator module for routing to a digital signal processor or media processing module, as applicable, prior to forwarding incoming IP voice packets and IP media packets encoded by a source device to said media processing module for receipt, and if the incoming IP voice packets and IP media packets received from said media separator are in said communications network then selected by said digital phone set user from the digital phone set, then said media processing module receives and decodes the incoming IP voice packets and IP media packets, and converts said decoded IP voice packets into outgoing voice signals and transmits the outgoing voice signals to said digital phone set user via the voice output and converts the decoded IP media packets into outgoing data signals and transmits the outgoing data signals to the user via the digital phone set display; and further characterized in that the at least on processing module, in encoding a particular IP voice packet or IP media packet, determines whether to encrypt a payload portion of the particular IP voice packet or IP media packet or both with a header and the payload portion of the particular packet base on an address of the destination device in the communications network selected by digital phone set user from the digital phone set; and further characterized in that said IP voice packets and IP media packets received by said media separator are blocked from transmission to the media processor, and ultimately blocked from output to said digital phone set user and digital phone set, if said IP voice packets and IP media packets are not associated with the communications network then currently selected by said digital phone set user from said digital phone set, thereby ensuring separation of critical network traffic; and further characterized in that at least one voice processing module converts the incoming voice signals of said digital phone set user into outgoing IP voice packets, encodes the outgoing IP voice packets and transmits the outgoing IP voice packets to a destination device on said communications network as selected by said digital phone set user from said digital phone set.
